(19) United States
(12) Patent Application Publication
(10) Pub. No.: US 2012/0005026 A1
(43) Pub. Date: Jan. 5, 2012

(54) METHODS, SYSTEMS AND COMPUTER READABLE MEDIA FOR UTILIZING A CONSUMER OPT-IN MANAGEMENT SYSTEM

(76) Inventors: Mohammad Khan, San Jose, CA (US); Pradeep Kumar, Fremont, CA (US); Hans Bielefeld Reisgies, San Jose, CA (US); Kaushik Roy, Foster City, CA (US); Roshan Vijayshankar, Santa Clara, CA (US)

(21) Appl. No.: 13/118,046

(22) Filed: May 27, 2011

Related U.S. Application Data
(60) Provisional application No. 61/349,106, filed on May 27, 2010.

(51) Int. Cl. G06Q 30/00

(52) U.S. Cl. 705/14.64

(57) ABSTRACT

Methods, systems, and computer readable media for utilizing a consumer opt-in management system are disclosed. According to one aspect, the method includes interfacing a near field communication (NFC) enabled mobile device with a touch point associated with an electronic marketing program to obtain touch point identification information from the touch point and receiving, at a trigger management server (TMS), an opt-in request message from the NFC enabled mobile device, wherein the opt-in request message includes a subscriber identifier associated with the NFC enabled mobile device and the touch point identification information. The method further includes accessing a business rules database using at least one of the subscriber identifier and the touch point identification information from the opt-in request message to identify an electronic marketing program identifier and using the electronic marketing program identifier to trigger the provisioning of content data associated with the electronic marketing program to the NFC enabled mobile device.

### PRIORITY CLAIM

This application claims the benefit of U.S. Provisional Patent Application Ser. No. 61/349,106, filed May 27, 2010, the disclosure of which is incorporated herein by reference in its entirety.

### TECHNICAL FIELD

The subject matter described herein relates to using an intelligent server to receive and manage opt-in requests for electronic certificates sent from NFC enabled mobile devices that interface with touch points. More particularly, the subject matter described herein relates to methods, systems, and computer readable media for utilizing a consumer opt-in management system (COMS).

### BACKGROUND

Recently, retailers and manufacturers have had difficulty introducing promotions or product offers to potential customers in an effective manner when new products are commercially launched. For example, retailers and manufacturers have traditionally used mass distribution methods to “broadcast” product offers and promotions to the general populace via printed circulars, newspapers, magazines, and the like. However, many of the people receiving the product offers typically have little or no interest in the promoted product. In many cases, the offers and promotions provided to the recipients are not location-based or fail to address the potential customers' current needs. Furthermore, the high production and distribution costs typically associated with conventional promotions (e.g., using paper advertisements and coupons) can significantly hinder the cost effectiveness of a typical product campaign.

Accordingly, there exists a need for methods, systems, and computer readable media for utilizing a consumer opt-in management system.

### BRIEF DESCRIPTION OF THE DRAWINGS

The subject matter described herein will now be explained with reference to the accompanying drawings of which:

FIG. 1 is a block diagram of an exemplary consumer opt-in management system according to an embodiment of the subject matter described herein; and

FIG. 2 is a flow chart of an exemplary method for utilizing a consumer opt-in management system according to an embodiment of the subject matter described herein.

### SUMMARY

Methods, systems, and computer readable media for utilizing a consumer opt-in management system are disclosed. Methods, systems, and computer readable media for utilizing a consumer opt-in management system are disclosed. According to one aspect, the method includes interfacing a near field communication (NFC) enabled mobile device with a touch point associated with an electronic marketing program to obtain touch point identification information from the touch point and receiving, at a trigger management server (TMS), an opt-in request message from the NFC enabled mobile device, wherein the opt-in request message includes a subscriber identifier associated with the NFC enabled mobile device and the touch point identification information. The method further includes accessing a business rules database using at least one of the subscriber identifier and the touch point identification information from the opt-in request message to identify an electronic marketing program identifier and using the electronic marketing program identifier to trigger the provisioning of content data associated with the electronic marketing program to the NFC enabled mobile device.

The subject matter described herein may be implemented in software, in combination with hardware and/or firmware. As such, the terms “function” or “module” as used herein refer to software being used in combination with hardware and/or firmware to perform the feature being described. For example, the subject matter described herein may be implemented in software executed by a processor. In one exemplary implementation, the subject matter described herein for utilizing a consumer opt-in management system may be implemented using a non-transitory computer readable medium to having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### DETAILED DESCRIPTION

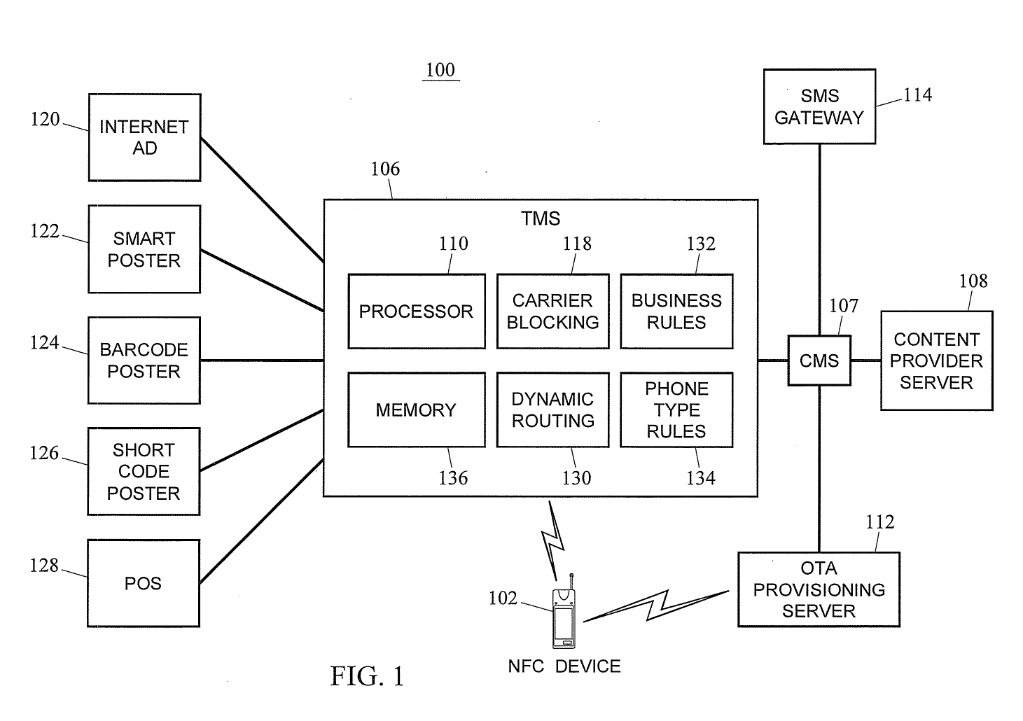

FIG. 1 is a block diagram of an exemplary consumer opt-in management system (COMS) 100 according to an embodiment of the subject matter described herein. As used herein, “opt-in” is intended to mean a consumer's intention to subscribe and/or grant of permission to participate in a merchant's electronic marketing program (e.g., a customer service program or electronic product campaign program), which is designed to deliver electronic coupons, promotions, ads, tickets, and the like to mobile devices belonging to a subscriber consumer). Likewise, the term “opt-out” is intended to mean a consumer's intention to unsubscribe or revoke the grant of permission to participate in the merchant's electronic marketing program. A subscriber may express the intent to opt-in by interfacing a near field communications (NFC) enabled mobile device with one or more touch points associated with a particular merchant entity. As used herein and discussed in more detail below, a touch point comprises a point of access or means for the subscriber's NFC enabled mobile device to opt-in (or opt-out of) a particular electronic marketing program associated with a merchant entity.

In one embodiment, COMS 100 comprises a plurality of components, which includes a near-field communications (NFC) enabled mobile handset or device 102, a plurality of touch points 120-128, a trigger management server (TMS) 106, a content management server (CMS) 107, at least one content provider server 108, an over-the-air (OTA) provisioning server 112, and a short message service (SMS) gateway 114. Although not shown, COMS 100 may also include other network elements that may be used in conjunction with TMS 106 to implement and facilitate a plurality of electronic marketing program, such as such as an electronic certificate-based campaign program (as described below) or a customer service program. Furthermore, although only one TMS is shown in FIG. 1, additional trigger management servers may be employed without departing from the scope of the present subject matter.

In one embodiment, TMS 106 may be used to intelligently manage one or more product campaign programs operated by one or more merchant entities or companies. As used herein, a “campaign program” involves the advertising and marketing that a company may conduct to promote a particular commercial product or service. A product campaign program may be used by a company to drive sales and increase brand exposure and awareness for a product (by utilizing efficient direct market media via promotions). One type of product campaign program is an electronic certificate-based campaign program, which utilizes electronic certificates, such as electronic coupons, offers, ads, tickets, promotions, and the like. An electronic certificate-based campaign program may involve the provisioning of these electronic coupons, promotions, and/or other electronic certificates (e.g., a soft card) to a consumer's NFC enabled mobile device provided the consumer has “opted in” to the electronic campaign program. In addition to provisioning electronic certificates to an NFC enabled mobile device via NFC, an electronic certificate-based campaign program may also involve providing electronic certificate codes to subscribers via SMS for subsequent redemption. By utilizing an electronic certificate-based product campaign program, merchants can significantly reduce advertising costs since the production and distribution costs that are incurred using an electronic medium are significantly lower in comparison to the expenses involved with conventional paper-based coupon campaigns. Moreover, electronic coupon certificates, electronic promotion certificates, and electronic codes stored on mobile devices have been known to have higher redemption rates than paper-based coupons because electronic certificates are usually not forgotten, not left at home, and not easily misplaced. In addition, electronic coupon certificates and electronic promotion certificates may be used to capture essential customer data by tracking individual transactions to obtain more accurate profiling and marketing information.

In one embodiment, TMS 106 is configured to receive an opt-in request message from an NFC enabled mobile device 102 that has interfaced with a touch point. Generally speaking, an opt-in request message is a request for, or a grant of permission to receive, electronic promotions, coupons, and product information provided by a merchant entity. An opt-in request message may also be an electronic request for a personalized service, a request for information (e.g., price information, sale information, etc.) regarding a product, or an indication of the customer's presence at a merchant location to a merchant entity (e.g., a retail department store). In one embodiment, a customer/subscriber may initiate an opt-in request by interfacing an NFC enabled mobile device with a touch point. In one embodiment, NFC enabled mobile device 102 provides a user with a means to interface with any one of the plurality of touch points 120-128. As mentioned above, a touch point is any object or entity which may be utilized by (e.g., tapped, interfaced with, etc.) an NFC enabled mobile device to opt into a customer service program or request an electronic certificate (e.g., an electronic coupon certificate, prepaid soft card, product information, promotional information, loyalty card, credit/debit card, content information, and the like) advertised by or associated with the touch point. Touch points may be used for promotion or advertising purposes by manufacturers conducting electronic product campaign programs related to the company's goods or service. In one embodiment, touch points may include an Internet advertisement 120, a smart poster 122, a bar code poster 124, a short code poster 126, and a point of sale (POS) terminal 128. Although FIG. 1 only shows exemplary touch points 120-128, other touch points (e.g., a parking meter, a shelf tag, etc.) may be used by the present subject matter without departing from the scope of the present subject matter.

Certain touch points (e.g., a smart poster or a wireless device reader at POS 128) may be configured to wirelessly communicate with NFC-enabled mobile device 102 using NFC via an electromagnetic field. Notably, NFC may occur at a distance of approximately one wavelength of the communications frequency being used between the mobile device and the touch point. An example of a contactless communications protocol that may be used in communications between a NFC enabled mobile device and a wireless device reader at a POS terminal is an ISO 14443 interface (i.e., a protocol/interface functioning in accordance with the ISO 14443 standard).

In one embodiment, a user may choose to receive an electronic certificate related to a good or service by interfacing (e.g., tapped against or positioned in close proximity to) NFC enabled mobile device 102 with a touch point, such as smart poster 122. Generally, a smart poster is embodied as a physical sign, billboard, or any other form of tangible advertising that incorporates a passive NFC smart tag (e.g., an RFID tag) from which the user can extract selected touch point identification information (e.g., tag identification information) by interfacing NFC enabled mobile device 102 with the smart tag. For example, a user may encounter a smart poster 122 advertising a particular good or service that interests the user. The touch point identification information acquired may be used to request a uniform resource locator (URL), a coupon, a prepaid card, a ticket, a promotion, or any other type of electronic data. For example, a user may utilize NEC enabled mobile device 102 to acquire or “pull” data (e.g., tag identification information or data) from a passive smart tag of smart poster 122. After interfacing with smart poster 122, mobile device 102 may initiate a midlet (e.g., a software client, such as a wallet client application program, executed by a mobile phone processor) that is responsible for transmitting touch point identification information and subscriber identification information (e.g., the customer's NFC enabled mobile device number) to TMS 106. For example, the midlet may send the touch point identification information to TMS 106 to opt-in the merchant's marketing program and/or request the electronic coupon advertised by the smart poster. In one embodiment, the touch point identification information may include at least one of: a tag identifier, a tag location code (TLC), a content provider code (CPC), and a terminal code depending on the touch point. For example, a tag identifier is a number that identifies a specific touch point, a TLC is a code that indicates the location of the touch point, and a CPC is a code that indicates the company or merchant entity providing the electronic certificate or data.

In one embodiment, Internet ad 120 includes a web-based advertisement or electronic coupon associated with an alphanumeric code that serves as an advertisement identifier. For example, a user may select the advertisement in a web browser of a mobile device (or in a web browser of any computer device/system) to obtain an electronic coupon or product information of the advertised product by submitting the phone number of the NFC enabled mobile device. In one embodiment, bar code poster 124 may be utilized by mobile device 102. Bar code poster 124 may include a passive poster or display with a bar code (such as a shelf tag, 2D bar code or QR code) that may be captured and processed by a mobile device (e.g., via a built-in camera). Similarly, a touch point may also include short code poster 126 that similarly comprises a passive poster that displays a short code to be entered in mobile device 102. By using a touch point associated with a particular merchant, a mobile device may be used to select and ultimately download an electronic certificate or promotion information to mobile device 102 by first communicating an opt-in request to TMS 106.

In one embodiment, TMS 106 includes an intelligent server that has been configured to receive opt-in (and opt-out) request messages from subscribers and to dynamically manage an electronic product campaign or customer service program. In one embodiment, TMS 106 includes a processor 110, a memory unit 136, a carrier blocking module 118, a dynamic routing module 130, a business rules database 132, and a phone type rules database 134. TMS 106 may be configured to receive opt-in request messages from mobile devices that have interfaced with touch points. For instance, after interfacing with a touch point, mobile device 102 may transmit an electronic certificate request (e.g., an opt-in request message) that provides TMS 106 with touch point identification information (which is associated with the interfaced touch point) and subscriber identification information. As an alternative to using touch points 120-128, the trigger for an opt-in request may be initiated by the mobile device while conducting a wallet search or being detected via WiFi triangulation, cellular triangulation, a GP3 operation, an RF field operation, and the like (e.g., when a customer's NFC enabled mobile device comes in close proximity to a department store entrance). Alternatively, if the subscriber identification information is not provided to TMS 106, the device user may be prompted by TMS 106 (via a message) to provide subscriber identification information, such as the user's mobile phone number or some other identifier associated with the user. In one embodiment, the opt-in request message contains a plurality of touch point identification information parameters that may be used by TMS 106 to process the message. For example, the touch point identification information parameters may include at least one of a tag location code (TLC), content provider code (CPC), a tag identifier, and/or a terminal code depending on the touch point.

In an electronic-based product marketing campaign, TMS 106 enables merchant entities to dynamically control the content data electronically provided to “opted-in” consumers and manage the scope of their product related advertisements and promotions (i.e., electronic campaign programs) by using business rules. In one embodiment, TMS 106 stores multiple business rules in business rules database 132, which may be configured and/or modified by an administrator or campaign manager. In one embodiment, business rules database 132 contains configurable software instructions (i.e., business rules) that when executed by processor 110 in TMS 106 may be used to identify an appropriate content management server and/or customize a particular product campaign program. For example, business rules database 132 may include database entries comprising touch point identification information mapped to electronic campaign program identifiers. Notably, TMS 106 may use the touch point identification information (e.g., the tag identifier, TLC/CLC, and time stamp) to query database 132 to determine a relevant marketing campaign. Once the current active marketing campaign is determined, TMS 106 may use an associated campaign identifier number or data contained in database 132 to query dynamic routing table 130 in order to obtain the destination IP address of a CMS associated with the determined active marketing campaign program. For example, the type of product information or electronic certificate data (e.g., an electronic coupon embodied as a softcard) that is ultimately available for download depends on the campaign or marketing/customer service program that is active. The active campaign may be determined by the merchant provider of the advertised product (e.g., as indicated by the CLC), the specific touch point interfaced (i.e., as indicated by the TLC), and the time, or date in which the mobile device interfaces with a particular touch point (i.e., as indicated by the timestamp). Once the campaign or marketing program is determined, a request message is routed to the correct CMS by obtaining the destination IP address of the CMS from table 130. Notably, databases 130 and 132 may each be modified by a campaign manager or administrator using/modifying the business rules. Thus, TMS 106 can be used to dynamically manage a touch point to provide different certificates, information, or options to a consumer (via a mobile device) based on business rule conditions that can be changed at TMS 106. Therefore, actual changes made to the touch points themselves are unnecessary. For example, by creating or modifying a business rule associated with a particular smart poster in database 132, the administrator of TMS 106 is enabled to indirectly configure that smart poster to provide an electronic coupon related to a first campaign or marketing program. That is, for a product on a particular day, and without modifying the smart poster itself, the campaign manager may modify the business rules (in the database) associated with the same smart poster so that only product information related to the first campaign or marketing program is provided that day. Alternatively, the business rules may be modified by a TMS administrator to provide electronic certificate data for an entirely different second campaign on the next day. This is advantageous since the existing infrastructure (e.g., smart posters, POS units, network nodes, etc.) largely remains unchanged even though product marketing campaigns are constantly being modified or replaced.

In one embodiment, TMS 106 can also be used to designate business rules based on the service carrier that provides service to the mobile device for carrier blocking options, or the model and the type of the mobile device being used in order to provide the subscriber user with an optimal experience for all operations. For example, TMS 106 may include a phone type rules database 134 that includes business rules for handling a promotion or electronic certificate request based on the serving carrier, model, and type of the requesting mobile device. For example, a vendor may decide to employ an electronic product campaign subjected to a carrier blocking option that effectively restricts the product campaign (i.e., a particular product offer or coupon) to subscribers of a particular network carrier. For example, carrier blocking module 118 may be used by TMS 106 (via processor 110) to determine if subscribers of a particular network carrier are permitted to participate in an electronic product campaign, and if necessary, prohibit blocked subscribers from obtaining requested electronic certificate data. For example, carrier blocking module 118 may comprise a database that contains a list of individual subscriber identifiers or a range of subscriber identifiers (e.g., IP addresses and telephone numbers of mobile devices) mapped to associated service carriers. In such a situation, certain business rules may be established in TMS 106 that permits only the mobile devices of these particular subscribers to obtain electronic certificates and product information from touch points designated by the vendor. If a non-subscriber device attempts to obtain a “restricted” electronic certificate (i.e., service carrier is blocked), the business rules in place prevent the associated transaction/download from occurring. Similarly, dynamic routing module 130 may be used by TMS 106 to access business rules database 132 and phone type rules database 134 to quickly modify content to be provided by one or more touch points 120-128.

As mentioned above, consumer opt-in management system 100 may also include CMS 107, content provider server 108, and an over-the-air (OTA) provisioning server 112. Although only one CMS, one content provider server, and one OTA provisioning server are shown in FIG. 1, additional servers may be employed without departing from the scope of the present subject matter. In one embodiment, CMS 107 is responsible for receiving opt-in trigger data (e.g., opt-in request messages or requests for electronic certificates) from TMS 106 and for forwarding each request to an appropriate merchant or content provider server. In one embodiment, CMS 107 helps manage the content data for the mobile device and other media provisioning based on the opt-in triggered information. CMS 107 may be interfaced with a number of trigger management servers, a number of merchant servers (i.e., content provider servers) using XML and other API interfaces, and a number of provisioning servers (e.g., OTA, IP, and/or direct based provisioning servers). Once the opt-in trigger data (e.g., campaign identifier, subscriber identification information, etc.) is received from TMS 106, CMS 107 then forwards the data to the appropriate merchant server based on the opt-in trigger data.

As used herein, the term “merchant” may include a seller, a retailer, or any other entity that is in the business of selling goods or providing services. In one embodiment, content provider server 108 may comprise a backend content provider server that is associated with a particular merchant such as a retailer, manufacturer, service provider, or Internet-based store. In one embodiment, content provider server 108 may include a content provider server that is associated with a plurality of merchants, manufacturers, companies, and the like. Content provider server 108 may be configured to store various electronic certificate data, such as coupons, promotional data, prepaid cards, loyalty cards, credit/debit cards, and/or product information. In one embodiment, based on the opt-in trigger data, content provider server 108 sends the relevant content data (e.g., offer or coupon) to CMS 107. CMS 107 may then prepare/process the content data (e.g., designating a protocol, specifying the encryption and authentication information, etc.) and subsequently pass the processed content data to OTA provisioning server 112 (or an IP provisioning server or direct provisioning server). In one embodiment, CMS 107 is also responsible for authenticating one or more content provider servers. For example, the content data stored in the content provider server may be predefined with an associated security level. In one embodiment, the security level for any content data may indicate a security level ranging from 1 to 10, wherein level 1 may indicate that there is no encryption and no authentication associated with the content data. Similarly, a security level 10 may indicate that the associated content data in the content provider server is fully encrypted and/or is to be fully authenticated. In one embodiment, once the content data is provided to CMS 107 by content provider server 108, CMS 107 may generate a digital certificate that designates the content issuer server as an authenticated source as indicated by the security level of the received content data. CMS 107 may then forward the digital certificate along with the content data to OTA provisioning server 112.

OTA provisioning server 112 may include any server that is responsible for receiving information (e.g., authenticated content data) from one or more content provider servers 108 via CMS 107 as well as issuing authenticated electronic certificates to NFC enabled mobile devices 102 per the instructions and information received from one or more content provider servers. The functions provided by OTA provisioning server 112 may include providing OTA administrative services for the secure element on a mobile device, and functioning as a secure local provisioning point for issuing authenticated electronic certificates to a mobile device. For example, OTA provisioning server 112 may be configured to receive content data and a digital certificate (indicating an authenticated source) from CMS 107. Upon receiving the authenticated content data, OTA provisioning server 112 may generate an authenticated electronic certificate to be wirelessly delivered to NEC enabled mobile device 102. Upon receiving the authenticated electronic certificate, NEC enabled mobile device 102 may be configured to display an icon or symbol (along with the content data or electronic certificate) that visually indicates that the received content data/electronic certificate is from an authenticated source or channel. In one embodiment, OTA provisioning server 112 may be embodied as a plurality of servers as opposed to a single stand-alone server as shown in FIG. 1.

Devices with wireless communications capabilities may also be capable of conducting data communications with remote entities. For example, devices with wireless communications capabilities may implement HTTP, CAT_TP (BIP) over TCP/IP, or SMSPP over-the-air (OTA) interface for communicating with remote entities. The OTA interface protocol used by a device with wireless communications capabilities may vary with the device. Examples of OTA interface protocols that may be used include GSM, GPRS, CDMA, Bluetooth, BIP (Bearer Independent Protocol), SMS PP, etc.

In one embodiment, TMS 106 may forgo using an OTA provisioning server 112 and instead utilize an SMS (or MMS or WAP) gateway 114 to send electronic certificate or product information/codes to the user's mobile device via SMS messages.

In one embodiment, the opt-in management system may be utilized to enhance a consumer's shopping experience. After opting-in to a customer service program at a store location (e.g., via a touch point), the consumer may be provided with electronic coupons, ads, promotions, tickets, and other data that may be used at the visited merchant location. In one scenario, a consumer or user with NFC enabled mobile device 102 may visit a department store located in a shopping mall. Although a department store is used in the following example, the merchant location may also include any other merchant store, restaurant, fast food establishment, cinema, sports venue, and the like without departing from the scope of the present subject matter. In order to optimize her shopping experience, the user may use NFC enabled mobile device 102 to opt-in the department store's customer service or marketing program. By opting-in, the subscriber is announcing her presence to the department store and her willingness to be served by the department store (e.g., by way of receiving personalized greetings, product information and prices, electronic coupons, customer reviews, advertisements, offers, and promotions). In one embodiment, the user may opt-in by interfacing NFC enabled mobile device 102 with a touch point (e.g., a smart poster enabled with NFC tag, a shelf tag with a bar code or NFC tag, etc.) located at the store's entrance to notify the merchant of the user's presence at the store. Alternatively, the touch point may be located in and associated with specific sections of the department store, such as the sporting goods section, housewares section, and the like. Upon interfacing with the touch point, NEC enabled mobile device 102 may obtain both a tag identifier that identifies the touch point and an address identifier (e.g., a URI or URL) associated with TMS 106. Using the TMS address identifier, a midlet in NEC enabled mobile device 102 may then transmit a subscriber identifier (e.g., a mobile phone number) and the tag identifier to TMS 106 via an opt-in request message.

TMS 106 may receive the opt-in request message and access the tag identifier from in order to determine an appropriate content management server to process the request message. In one embodiment, processor 110 uses the tag identifier to access business rules database 132 to determine the appropriate CMS to forward the tag identifier and subscriber data and/or to determine if the request message is associated with a product campaign. For example, business rules database 132 may indicate that any request message containing the received tag identifier should be forwarded to CMS 107. Business rules database 132 may take into account at any number of factors in addition to the tag identifier (e.g., a time stamp, a subscriber identifier, etc.).

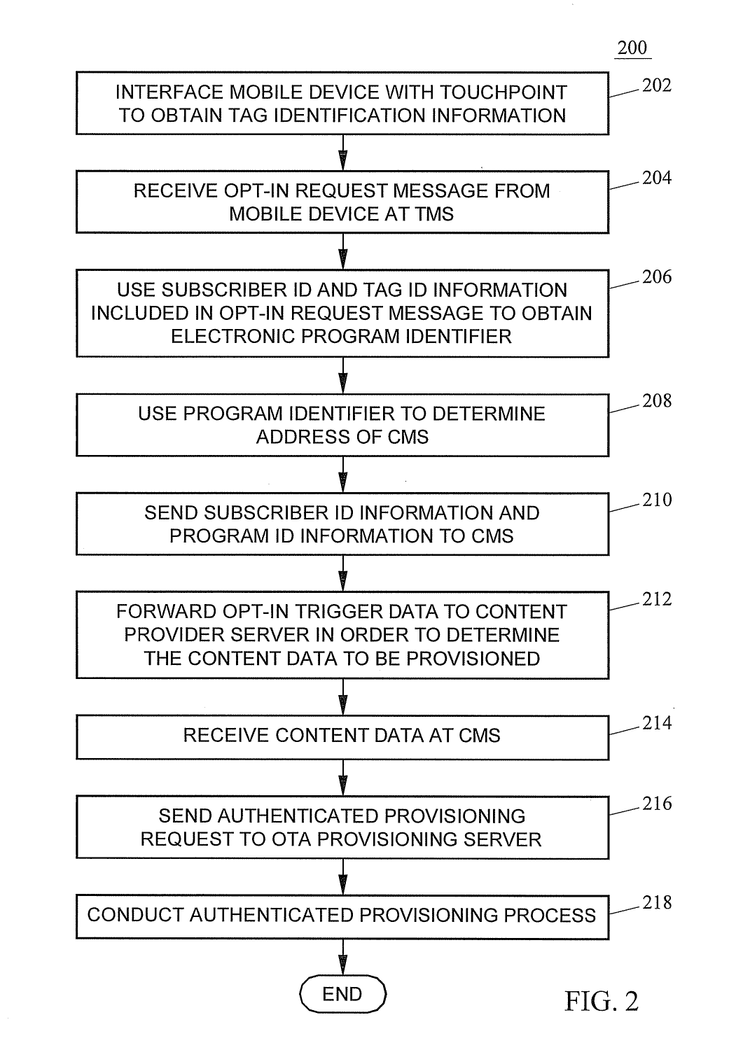

After receiving the forwarded request message, CMS 107 locates the correct content provider server (i.e., merchant server) associated with tag identifier. For example, if the tag identifier identifies a particular smart poster located at the entrance of a Macy's department store, then CMS 107 is provisioned to locate a content provider server (e.g., content provider server 108) that contains Macy's electronic certificate content (e.g., electronic coupons, promotions, tickets, etc.). By locating a specific content provider server associated with a specific merchant, the present subject matter effectively creates a closed loop opt-in system for that merchant. In one embodiment, the closed loop opt-in system allows a merchant entity to deliver controlled information through the touch points located within the merchant entity's premises (e.g., a store). For example, the closed loop opt-in system may thereby enable the merchant entity to control the type of information that can be delivered to consumers when these consumers interface/tap (i.e., opt-in) their NFC handsets on touch points located within the merchant's stores. Thus, the closed loop system allows the merchant entity to not only control the type and richness of information the merchant wants to deliver to its customers, but it also assures the data content delivered at the merchant location is properly controlled/managed (e.g., authenticated) to avoid offending/annoying customers by preventing the delivery of unwanted data and messages. This authentication mechanism may also be used to avoid or reduce spam content being delivered to NFC mobile devices belonging to opted-in consumers. Using the subscriber identifier, CMS 107 may be able to obtain electronic certificates that are directed and appropriate for the subscriber opting in. For example, content provider server 108 may be pre-provisioned with information that indicates that the requesting subscriber has a history of purchasing a particular brand of cologne. Accordingly, content provider server 108 may provide an electronic coupon or promotion associated with that cologne type to CMS 107 for delivery to the subscriber's NFC enabled mobile device 102. In one embodiment, delivery of the electronic certificate may be made via OTA provisioning server 112. Alternatively, the electronic certificate may be delivered to NFC enabled mobile device 102 as an SMS message via SMS gateway 114. By employing the system described above, a merchant is able to provide any customer that opts into the merchant's customer service or marketing program at the entrance of a store with coupons and ads that are pertinent/interesting to the user. The subscriber may continue to receive periodic electronic certificates from CMS 107 until a predefined time period or until the user “opts out”. By opting out, the subscriber is effectively terminating the permission of the merchant to send messages to NFC enabled mobile device 102. Thus, the subscriber can actively prevent receiving any further electronic certificates from the merchant either after she leaves the store or any other time (e.g., even while the customer is shopping). In one embodiment, the user may opt-out by interfacing her NFC enabled mobile device with a touch point, upon detection (via WiFi, GPS triangulation, etc.) that the NFC enabled mobile device has left the merchant location, or using the NFC enabled mobile device to send an opt-out request message to TMS 106. This opting in and opting out mechanism enables the subscriber to prevent spam messaging from unauthorized or unauthenticated sources as well as unwanted messages from the merchant. As mentioned above, once a touch point is interfaced by a mobile device, an opt-in request message to participate in a merchant's program or product campaign is sent to TMS 106. Details regarding an exemplary process for managing and processing requests at TMS 106 in the consumer opt-in management system are set forth in method 200 as depicted in FIG. 2. Although FIG. 2 is directed to the interfacing an NFC enabled mobile device with a smart poster, method 200 may be applied to the use of any other like touch point without departing from the scope of the present subject matter.

In block 202, an NFC enabled mobile device is interfaced with a touch point. By interfacing with a touch point, the mobile device enables the subscriber/customer to opt-in to a merchant's electronic marketing program, such as customer service program or electronic certificate based campaign program. In one embodiment, mobile device 102 interfaces with a smart poster by either tapping the smart poster or being placed in close proximity to the smart poster (e.g., close enough to utilize NFC). For example, mobile device 102 may be used to tap a smart tag on smart poster 122. Similarly, the touch point may instead be a bar code poster that is interfaced with mobile device 102. For example, mobile device 102 may be equipped with a camera that is used to capture a bar code (e.g., a 2D bar code, a QR code, etc.) on a bar code poster 124 (or shelf tag) and a software application executed by a processor to interpret the bar code image. Mobile device 102 may also interface with a POS touch point by being positioned in close proximity with POS terminal 128. In one embodiment, POS terminal 128 may include a wireless device reader (not shown) or any device (e.g., a wireless RFID reader or a contactless card reader) capable of reading NFC enabled mobile devices. In an alternate embodiment, a user may select an Internet advertisement 120 displayed on Internet browser 126 on mobile device 102. As a result of interfacing with any of the aforementioned touch points, mobile device 102 may receive touch point identification information in a wireless manner (e.g., via NFC). In one embodiment, the touch point identification information includes at least one of a tag identifier, a CLC and a TLC.

In block 204, an opt-in request message from the NFC enabled mobile device is received at TMS 106. In one embodiment, after conducting the opt-in procedure (i.e., interfacing with a touch point), mobile device 102 may initiate an opt-in request message to TMS 106 using either the mobile device's Internet browser application or the mobile device's midlet (e.g., wallet application). The opt-in request message from the mobile device 102 may include both touch point identification information and subscriber identifier information. In one embodiment, the touch point identification information may include a tag identifier, a content provider code (CPC) and tag location code (TLC) obtained from the touch point as well as time stamp information and the address of TMS 106 (e.g., an IP address, such as a URL or URI, or fully qualified domain name (FQDN) of TMS 106). In one embodiment, the opt-in request message is a request for electronic certificate data or product information advertised/promoted by the touch point at the time the mobile device interfaces with the touch point.

In another embodiment, the opt-in request message is a grant of permission for the merchant to send electronic coupons, promotions, tickets, and the like to mobile device 102. Specifically, after mobile phone 102 interfaces with smart poster 122, the midlet of mobile device 102 transmits the opt-in request message to TMS 106 at the designated IP address/FQDN provided by smart poster 122.

In block 206, subscriber identification information and touch point identification information included in the opt-in request message may be used to obtain information about the electronic marketing campaign or the merchant's customer service program. For example, using the information in the request message (e.g., a location code, content provider code, subscriber identification information and/or a time stamp), TMS 106 is able to query database 132 in order to determine the specific electronic marketing campaign associated with the touch point. In one embodiment, TMS 106 may cross-reference the timestamp in the request message with a time window of the currently active marketing campaign or the currently active customer service program.

In block 208, program information is used to determine the address information of a serving CMS. In one embodiment, TMS 106 may obtain program information (i.e., opt-in trigger data) from the business rules database 132 that includes a destination IP address of the particular CMS (e.g., CMS 107) that is responsible for supporting the electronic marketing campaign or customer service program in question.

In block 210, the subscriber identification information and program identifier is sent to the serving CMS. In one embodiment, TMS 106 sends the subscriber's mobile phone number and the program identifier (i.e., opt-in trigger data) to CMS 107.

In block 212, the subscriber identification information and program identifier is forwarded to a content provider. In one embodiment, CMS 107 queries a database of merchant server 108 mapped to program identifiers in order to determine the specific content provider server (i.e., merchant server) that contains the content requested (or granted permission to be received) by the mobile device. CMS 107 then forwards the opt-in trigger data to the selected merchant server, which subsequently locates the appropriate content data. For example, content provider server 108 determines the type of electronic certificate data or product information that is ultimately provided to the mobile device by referencing content databases using merchant and location identifiers that indicate the active program and the touch point that was used. In an alternate embodiment, the content databases may simply be queried by merchant server 108 using a campaign identifier provided by CMS 107. In another embodiment, CMS 107 may also provide the subscriber identifier (e.g., mobile device phone number) to the content provider server 108. In such a case, content provider server 108 may then provide subscriber-specific coupons to the mobile device based on the subscriber's recorded purchase history.

In block 214, the content data is received at the CMS. In one embodiment, content provider server 108 sends the appropriate content data, such as an electronic coupon or promotion offer, back to CMS 107. CMS 107 may then further process the content data. For example, CMS 107 may add information, such as the protocol to be used, to the content data as well as taking measures to encrypt and authenticate information specified for the content data. By authenticating the content data, CMS 107 is able to provide content information that is readily accepted by mobile device 102 (i.e., to distinguish the content data from spam content).

In block 216, CMS 107 sends a provisioning request message. In one embodiment, CMS 107 sends a provisioning request message along with the processed (e.g., authenticated) content data to OTA provisioning server 112, wherein the message includes instructions to generate and provide an electronic certificate containing the authenticated content data to mobile device 102. In short, content server 108 determines the content data to be provided to the subscriber, provides the content data to CMS 107, which then relays authenticated content information to OTA provisioning server 112 (via CMS 107) for the actual provisioning of electronic certificate data or product information on mobile device 102.

In block 218, the electronic certificate is provided to the mobile device. In one embodiment, OTA provisioning server 112 sends a control SMS message (via SMS gateway 114) to NFC enabled mobile device 102. A client application of mobile device 102 is then instructed by a control short (binary) message to initiate a download process. Mobile device 102 may also send a message acknowledging receipt of the control short message to OTA provisioning server 112. In one embodiment, OTA provisioning server 112 receives a message acknowledging the receipt of the control message from the client application in mobile device 102. OTA provisioning server 112 then establishes a secured line of communications with the wallet client and secure memory and/or mobile base band memory of mobile device 102 using GPRS, GSM, CAT_TP, BIP or SMS/SMS PP. In one embodiment, OTA provisioning server 112 uploads the electronic certificate and provides information data to the secured element in mobile device 102 over the established secured link. Similarly, branding/issuer marketing data may also be uploaded to mobile device 102 along with the electronic certificate data and product information. In an alternate embodiment, the creation of the secure link and use of a secure element in mobile device 102 is not necessary. For example, the coupon data may instead be transmitted over a non-secure link and stored in general memory of mobile device 102. In yet another embodiment, TMS 106 gives OTA address to mobile device 102 which then initiates the provisioning process with a request.

As indicated above, at any time after opting in (i.e., before or after receiving any data from a merchant entity), the subscriber of the mobile device may be used to “opt-out”. By opting out of the product marketing campaign or customer service program, the subscriber is effectively terminating the grant of permission to receive any further electronic coupons, promotions, tickets, and the like from the previously authorized merchant entity. Notably, this opt-out mechanism may be implemented to reduce and/or eliminate any spam directed to the mobile device.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for utilizing a consumer opt-in management system, the method comprising:
interfacing a near field communication (NFC) enabled mobile device with a touch point associated with an electronic marketing program to obtain touch point identification information from the touch point;
receiving, at a trigger management server (TMS), an opt-in request message from the NFC enabled mobile device, wherein the opt-in request message includes a subscriber identifier associated with the NFC enabled mobile device and the touch point identification information;
accessing a business rules database using at least one of the subscriber identifier and the touch point identification information from the opt-in request message to identify an electronic marketing program identifier; and
using the electronic marketing program identifier to trigger the provisioning of content data associated with the electronic marketing program to the NFC enabled mobile device.

2. The method of claim 1 wherein using the electronic marketing program identifier includes providing the electronic marketing program identifier and the subscriber identifier to a content management server (CMS).

3. The method of claim 2 wherein the using the electronic marketing program identifier includes determining, at the CMS, the appropriate content provider server that contains the content data.

4. The method of claim 3 wherein using the electronic marketing program identifier includes obtaining the content data from the content provider server using at least one of the electronic marketing program identifier and the subscriber identifier.

5. The method of claim 4 wherein using the electronic marketing program identifier includes providing the content data from the content provider server to an over the air (OTA) provisioning server via the CMS.

6. The method of claim 5 wherein using the electronic marketing program identifier includes, at the OTA provisioning server, using the content data to generate an electronic certificate, and delivering the electronic certificate to the NFC enabled mobile device.

7. The method of claim 5 wherein the content provider server is indicated as an authenticated source by a content management server.

8. The method of claim 1 wherein, in response to receiving an opt-out message from the NEC enabled mobile device the TMS server sends an instruction message to cease the provisioning of the content data to the NFC enabled mobile device.

9. The method of claim 1 wherein accessing a business rules database includes:
utilizing the subscriber identifier to determine a service carrier that provides service to the NFC enabled mobile device;
determining if the service carrier is blocked from participating in the electronic marketing program; and
if the service carrier is not blocked, proceeding to process the opt-in request message.

10. The method of claim 9 further comprising preventing the transmission of the requested electronic certificate to the NFC enabled mobile device if the service carrier is not participating in the electronic marketing program.

11. The method of claim 1 wherein the touch point includes at least one of a smart poster, a bar code poster, a short code poster, a point of sale device, a parking meter, a shelf tag, and an Internet advertisement.

12. The method of claim 1 wherein the touch point identification information includes at least one of content provider code (CPC) and a tag location code (TLC) associated with the touch point.

13. The method of claim 1 wherein interfacing the NEC enabled mobile device with the touch point includes acquiring the touch point identification information from the touch point via near-field communications.

14. The method of claim 1 wherein the subscriber identifier includes at least one of an Internet protocol (IP) address and a telephone number associated with the NFC enabled mobile device.

15. The method of claim 1 wherein the request message includes a timestamp indicating the date and time the mobile device interfaced with the touch point.

16. The method of claim 1 wherein the NFC enabled device displays a symbol or icon indicating that a source of the received content data is an authenticated source.

17. The method of claim 4 wherein the touch point is located a merchant location and the content data contained in the content provider server is associated with the merchant location.

18. The method of claim 5 wherein the content provider server is authenticated by the content management server to avoid delivery of spam content to the NFC enabled mobile device.

19. A consumer opt-in management system, the system comprising:
a touch point associated with an electronic marketing program configured for providing touch point identification information when interfaced with a near field communication (NFC) enabled mobile device; and
a triggering management server (TMS) for receiving an opt-in request message from the NFC enabled mobile device, wherein the opt-in request message includes a subscriber identifier associated with the NFC enabled mobile device and the touch point identification information, for accessing a business rules database using at least one of the subscriber identifier and the touch point identification information from the opt-in request message to identify an electronic marketing program identifier, and for using the electronic marketing program identifier to trigger the provisioning of content data associated with the electronic marketing program to the NFC enabled mobile device.

20. The system of claim 19 wherein the TMS is further configured to provide the electronic marketing program identifier and the subscriber identifier to a content management server (CMS).

21. The system of claim 20 wherein the CMS is further configured to determine, at the CMS, the appropriate content provider server that contains the content data.

22. The system of claim 21 wherein the CMS is further configured to obtain the content data from the content provider server using at least one of the electronic marketing program identifier and the subscriber identifier.

23. The system of claim 22 wherein the content data is provided from the content provider server to an over the air (OTA) provisioning server via the CMS.

24. The system of claim 23 wherein using the OTA provisioning server is configured to use the content data to generate an electronic certificate and to deliver the electronic certificate to the NFC enabled mobile device.

25. The system of claim 23 the content provider server is indicated as an authenticated source by a content management server.

26. The system of claim 19 wherein the TMS is further configured to, in response to receiving an opt-out message from the NEC enabled mobile device, send an instruction message to cease the provisioning of the content data to the NEC enabled mobile device.

27. The system of claim 19 wherein the TMS is further configured to:
utilize the subscriber identifier to determine a service carrier that provides service to the NEC enabled mobile device;
determine if the service carrier is blocked from participating in the electronic marketing program; and
if the service carrier is not blocked, proceed to process the opt-in request message.

28. The system of claim 27 wherein the TMS is further configured to prevent the transmission of the requested electronic certificate to the NFC enabled mobile device if the service carrier is not participating in the electronic marketing program.

29. The system of claim 19 wherein the touch point includes at least one of a smart poster, a bar code poster, a short code poster, a point of sale device, a parking meter, a shelf tag, and an Internet advertisement.

30. The system of claim 19 wherein the touch point identification information includes at least one of content provider code (CPC) and a tag location code (TLC) associated with the touch point.

31. The system of claim 19 wherein the NFC enabled mobile device is configured to acquire the touch point identification information from the touch point via NEC.

32. The system of claim 19 wherein the subscriber identifier includes at least one of: an Internet protocol (IP) address or a telephone number associated with the NEC enabled mobile device.

33. The system of claim 19 wherein the opt-in request message includes a timestamp indicating the date and time the mobile device interfaced with the touch point.

34. The system of claim 19 wherein the NFC enabled device displays a symbol or icon indicating that the source of the received content data is an authenticated source.

35. The system of claim 22 wherein the touch point is located a merchant location and the content data contained in the content provider server is associated with the merchant location.

36. The system of claim 23 wherein the content provider server is authenticated by the content management server to avoid delivery of spam content to the NEC enabled mobile device.

37. A computer readable medium having stored thereon non-transitory computer executable instructions that when executed by a processor of a computer performs steps comprising:
interfacing a near field communication (NFC) enabled mobile device with a touch point associated with an electronic marketing program to obtain touch point identification information from the touch point;
receiving, at a trigger management server (TMS), an opt-in request message from the NFC enabled mobile device, wherein the opt-in request message includes a subscriber identifier associated with the NFC enabled mobile device and the touch point identification information;
accessing a business rules database using at least one of the subscriber identifier and the touch point identification information from the opt-in request message to identify an electronic marketing program identifier; and
using the electronic marketing program identifier to trigger the provisioning of content data associated with the electronic marketing program to the NFC enabled mobile device.
